(19) United States
(12) Patent Application Publication
(10) Pub. No.: US 2017/0002737 A1
(43) Pub. Date: Jan. 5, 2017

(54) Heating System for Backup Generator

(71) Applicant: Ray Popejoy, Fairbury, IL (US)

(72) Inventor: Ray Popejoy, Fairbury, IL (US)

(21) Appl. No.: 15/198,385

(22) Filed: Jun. 30, 2016

Related U.S. Application Data
(60) Provisional application No. 62/186,478, filed on Jun. 30, 2015.

(51) Int. Cl. F02C 7/047; H01M 10/615; H02J 9/08

(52) U.S. Cl. CPC F02C 7/047; H02J 9/08; H01M 10/615

(57) ABSTRACT

A heating system for a backup generator for ensuring that a generator unit does not malfunction due to low ambient temperatures. The heating system includes a heater adapted to be installed within the generator unit housing and adjacent to a generator for use in providing heat to the generator. A heating pad is further provided, wherein a battery of the backup generator is adapted to be positioned on the heating pad. The heater and heating pad are operably connected to a thermostat that determines the temperature within the generator unit. The heater and heating pad are adapted to begin producing heat if the thermostat detects that the temperature has dropped below a predetermined temperature minimum. A high limit switch is further provided to turn off the heater and heating pad when the temperature within the generator housing has reached a predetermined temperature maximum.

### CROSS REFERENCE TO RELATED APPLICATION

This application claims the benefit of U.S. Provisional Application No. 62/186,478 filed on Jun. 30, 2015. The above identified patent application is herein incorporated by reference in its entirety to provide continuity of disclosure.

### BACKGROUND OF THE INVENTION

### Field of the Invention

The present invention relates to heating devices. More specifically, the present invention provides a heating system for a backup generator that is adapted to warm the components of a generator so as to facilitate proper operation of the backup generator during periods of cold weather.

Standby or backup generators are often used by homes and businesses to provide electricity to the home or business when there is a utility power outage. The backup generator detects the power loss from the utility and begins to produce electricity to fulfill the home or business's electrical load. This is particularly useful in areas that frequently experience blackouts as the result of storms or other inclement weather conditions, or due to issues with the utility and transmission lines.

During periods of cold weather, however, the generator may have difficulty beginning to operate once a power outage occurs. The cold can cause one or more components of the generator to freeze. Additionally, frost and snow can interfere with the operation of the generator. As a result, the generator may take considerable time to begin producing electricity or may malfunction and fail to provide electricity. Alternatively, the generator can crack or otherwise become damaged if forced to operate in extreme temperature conditions.

In order to ensure that the generator works properly in periods of cold weather, it is useful to warm or preheat the generator to raise the temperature of the components thereof and so as to remove frost or snow that has accumulated on or in the generator. However, there are currently limited options for heating the generator to ensure the components can function properly.

Devices have been disclosed in the prior art that relate to battery heating or warming devices. These include devices that have been patented and published in patent application publications. Some devices in the prior art relate to self-heating batteries, such as U.S. Published Patent Application Number 2006/0012342, U.S. Pat. No. 6,002,240, and U.S. Published Patent Application Number 2012/0126753. Other devices in the prior art relate to devices suited for warming or heating a battery, such as U.S. Pat. No. 5,281,792 and U.S. Pat. No. 6,259,229.

These prior art devices have several known drawbacks. The devices in the prior art fail to provide systems for heating a generator to ensure the generator functions properly during periods of cold weather. Instead, the devices in the prior art only provide devices for heating or warming a battery. Such devices are not suited for heating the components of a generator and are not adapted for use with a generator.

In light of the devices disclosed in the prior art, it is submitted that the present invention substantially diverges in design elements from the prior art and consequently it is clear that there is a need in the art for an improvement to existing generator heating systems. In this regard the instant invention substantially fulfills these needs.

### SUMMARY OF THE INVENTION

In view of the foregoing disadvantages inherent in the known types of heating systems now present in the prior art, the present invention provides a new heating system for a backup generator wherein the same can be utilized for providing convenience for the user when ensuring that a generator is at a temperature that allows for proper functioning thereof.

The present invention provides a heating system for a backup generator for ensuring that the generator functions properly during periods of cold weather. The heating system comprises a heater adapted to be installed within the generator unit housing and adjacent to the generator for use in providing heat thereto. A heating pad is further provided, wherein the battery of the generator is adapted to be positioned on the heating pad. The heater and heating pad are operably connected to a thermostat adapted to determine the temperature within the generator housing. The heater and heating pad are adapted to begin producing heat if the thermostat detects that the temperature has dropped below a predetermined minimum temperature. A high limit switch is further provided to turn off the heater and heating pad when the temperature within the generator housing has reached a predetermined maximum temperature.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic diagram of the components of the heating system.

FIG. 2 shows a diagram of the heating system as installed within a generator housing.

### DETAILED DESCRIPTION OF THE INVENTION

Reference is made herein to the attached drawings. Like reference numerals are used throughout the drawings to depict like or similar elements of the heating system for a backup generator. For the purposes of presenting a brief and clear description of the present invention, the preferred embodiment will be discussed as used for warming or heating a generator so as to ensure the generator functions properly during periods of cold weather. The figures are intended for representative purposes only and should not be considered to be limiting in any respect.

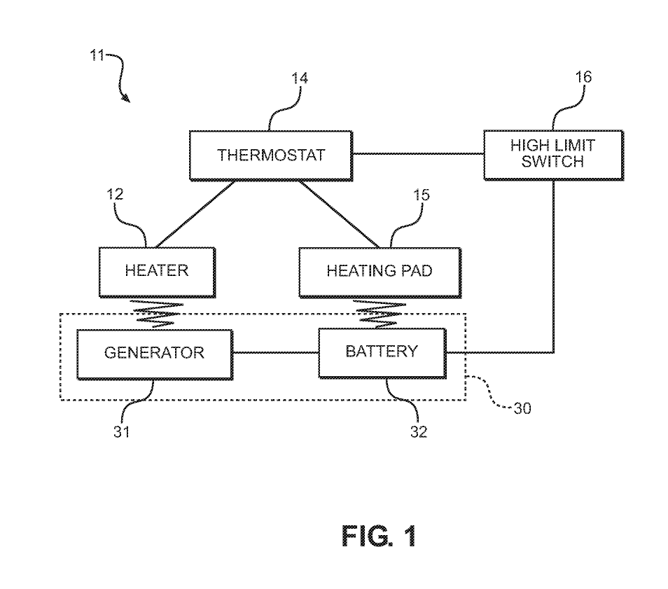

Referring now to FIG. 1, there is shown a schematic diagram of the components of the heating system. The heating system 11 comprises a heater 12 adapted to be positioned within a generator unit 30 and adjacent to a generator 31 therein. The heater 12 is adapted to produce heat to warm the generator 31 to ensure the generator 31 functions properly. Preferably, the heater 12 is spaced a proper distance from the generator 31 in order to prevent the generator 31 from overheating, as well as to provide ambient heating. In one embodiment, the generator 31 is a combustion engine that utilizes gasoline, diesel, or other power sources. However, in an alternative embodiment, the generator 31 may be a natural gas generator.

A heating pad 15 is also provided, wherein the heating pad 15 is adapted to be positioned within the generator unit 30 to heat the battery 32 therein. The heating pad 15 is adapted to be disposed directly underneath the battery 32 so that the battery 32 contacts the heating pad 15. Preferably, the heating pad 15 comprises a flexible panel having a heating mechanism therein. In some embodiments, the heating mechanism comprises one or more electrical resistance heating elements therein that produce heat when electrical current is supplied thereto. However, in alternate embodiments, the heating pad 15 may include other types of heating mechanisms suitable for providing heat to warm the battery 32. In one use, the heating pad 15 heats the temperature of the battery 32 to between 40 degrees Fahrenheit and 50 degrees Fahrenheit. Thus, the battery 32 performance is optimal and not adversely affected by low temperatures.

A thermostat 14 is operably connected to the heater 12 and to the heating pad 15. The thermostat 14 is adapted to determine the temperature within the generator unit 30. In some embodiments, the thermostat 14 is specifically adapted to determine the temperature of the generator 31 and battery 32. The thermostat 14 is configured to activate the heater 12 and the heating pad 15 when the temperature within the generator unit 30 has dropped below a predetermined temperature minimum. When the temperature is below the predetermined temperature minimum, the generator unit 30 is at risk of failing to function properly, and as a result the heating system 11 is configured to provide heat to the generator unit 30 when the temperature becomes lower than the predetermined temperature minimum. In one embodiment, the heater 12 heats the temperature of the generator 31 to between 40 degrees Fahrenheit and 50 degrees Fahrenheit. Thus, the generator 31 performance is optimal and not adversely affected by low temperatures or by excessively high temperatures.

A high limit switch 16 is further provided, wherein the high limit switch 16 is in communication with the thermostat 14. The high limit switch 16 is configured to cause the heater 12 and heating pad 15 to deactivate or stop producing heat when a predetermined temperature maximum is reached. This helps to prevent overheating of the generator 31 and/or battery 32 which can cause malfunction of the generator unit 30 or damage thereto. The predetermined temperature maximum may be 50 degrees Fahrenheit in some embodiments.

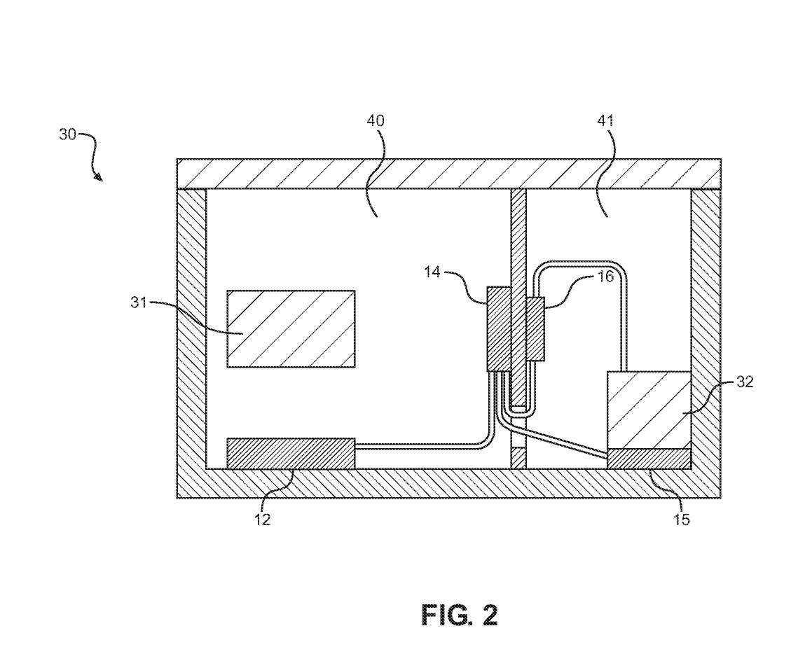

Referring now to FIG. 2, there is shown a cross sectional view of the generator heating system as installed within a generator unit. In operation, the battery 32 of the generator unit 30 provides power to the heating system of the present invention. In the shown embodiment, the generator unit 30 comprises a generator compartment 40 and a battery compartment 41, wherein the generator 31 is disposed within the generator compartment 40 and the battery 32 is disposed within the battery compartment 41. The battery 32 is electrically connected to the high limit switch 16. The high limit switch 16 serves to cut power to the heater 12 and heating pad 15 if the temperature within the generator compartment 40 and the battery compartment 41 has reached the predetermined temperature maximum.

The thermostat 14 is electrically connected to the high limit switch 16 and is adapted to determine the ambient temperature within the generator unit 30. The heater 12 and heating pad 15 are electrically connected to the thermostat 14. If the temperature has dropped below a predetermined temperature minimum, the heater 12 and heating pad 15 are automatically activated so as to begin producing heat. The predetermined temperature minimum is preferably one below which the performance of the generator unit 30 is impacted. For example, in some embodiments the predetermined temperature minimum is 40 degrees Fahrenheit.

The thermostat 14 and the high limit switch 16 are configured to be mounted within the generator unit 30 and can be mounted at various locations therein via any of various conventional fastening methods, such as by use of screws, bolts, and the like. Preferably, the thermostat 14 is positioned in an area adjacent to the generator 31 so as to determine the temperature in the area close by the generator 31.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A heating system for a backup generator, comprising:
a heater configured to provide heat to a generator when placed adjacent thereto;
a heating pad configured to provide heat to a battery when placed adjacent thereto;
a thermostat operably connected to the heater and the heating pad, wherein the thermostat is adapted to detect a temperature of the generator and a temperature of the battery;
wherein the thermostat is configured to activate the heater if the temperature of the generator falls below a predetermined minimum temperature;
wherein the thermostat is configured to activate the heating pad if the temperature of the battery falls below a predetermined minimum temperature.

2. The heating system for a backup generator of claim 1, wherein
the thermostat is adapted to deactivate the heater if the temperature of the generator exceeds a predetermined maximum temperature.

3. The heating system for a backup generator of claim 1, wherein
the thermostat is adapted to deactivate the heating pad if the temperature of the battery exceeds a predetermined maximum temperature.

4. The heating system for a backup generator of claim 1, wherein
the heater is configured to heat the temperature of the generator to between 40 degrees Fahrenheit and 200 degrees Fahrenheit.

5. The heating system for a backup generator of claim 1, wherein
the heating pad is configured to heat the temperature of the battery to between 40 degrees Fahrenheit and 200 degrees Fahrenheit.

6. The heating system for a backup generator of claim 1, wherein:
the heating pad comprises a flexible panel having one or more electrical resistance heating elements therein.

7. A heating system for a backup generator of claim 1, further comprising:
a generator unit including a generator compartment and a battery compartment;
wherein the generator is disposed within the generator compartment and the battery is disposed within the battery compartment.

8. A heating system for a backup generator of claim 7, wherein:
the heater is disposed within the generator compartment and adjacent to the generator; and
the heating pad is disposed within the battery compartment and adjacent to the battery.
